(19) United States
(12) Patent Application Publication
(10) Pub. No.: US 2017/0262417 A1
(43) Pub. Date: Sep. 14, 2017

(54) SUMMARIZED DOCUMENT VERSION MAP

(71) Applicants: Perry Ziff, New York, NY (US); David Baum, Zaporizhia (UA); Serhii Shalaiev, Dnipro (UA)

(72) Inventors: Perry Ziff, New York, NY (US); David Baum, Zaporizhia (UA); Serhii Shalaiev, Dnipro (UA)

(73) Assignee: Agreewithme Inc., New York, NY (US)

(21) Appl. No.: 15/458,932

(22) Filed: Mar. 14, 2017

Related U.S. Application Data
(60) Provisional application No. 62/307,768, filed on Mar. 14, 2016.

(51) Int. Cl. G06F 17/24; G06F 17/30

(52) U.S. Cl. CPC G06F 17/24; G06F 17/30011; G06F 17/30864; G06F 17/30905

(57) ABSTRACT

A method and system for rendering and displaying a graph summarizing the history of revisions to a document are provided. The graph provides a simplified visualization of relationships and status of versions of a document that help answer a variety of important questions during the process of drafting and revising documents. The method provides for the summarization of arbitrarily complex revision histories by employing an algorithm that takes information about a user's role and rights related to the document and various revision events and sequences of revision events pertaining to a subset of revisions as input and translating these events into summarized descriptors which can be graphically represented through visual indicators.

This application is a non-provisional application of provisional patent application number 62/307,768, filed on Mar. 14, 2016, and priority is claimed thereto.

### FIELD OF THE PRESENT INVENTION

The present invention relates generally to the field of document revision management systems, and more particularly to a method and system for enabling a plurality of users to efficiently and effectively view a customized summary of the current status and history of revisions to a document and control the revision management process.

### BACKGROUND OF THE PRESENT INVENTION

Creating or modifying a document with the assistance of other individuals can be a complex process. The process typically involves an “owner” of a document creating an original draft and then distributing copies of the draft, or sections of the draft, to one or more individuals (“reviewers”) for their comment and/or editing. The reviewers complete their review and return their revised draft containing their comments and/or edits to the document owner. The owner upon receiving these drafts will review the input provided and decide which changes and suggestions to accept and incorporate into a new draft of the document. The owner will then decide whether to repeat this process using the new draft of the document. The owner may decide to distribute a new draft and request additional input from one or more of the same reviewers and/or include new individuals in the review. If the owner has permitted, a reviewer may invite other individuals to provide their input on the same draft or may create a new working draft for any newly invited individual. This cycle may be repeated many times before the owner decides the last draft of the document is final.

The complexity of managing this revision process is increased by: a) the number of individuals involved; b) the number of drafts created and distributed; c) the asynchronous nature of each cycle with each reviewer (e.g., each reviewer can receive, review, and submit changes at their own pace, thus reviewers may be reviewing and submitting changes from different drafts at nearly the same time); and d) reviewers inviting others to review a draft of a document they have received from the document owner. This complexity requires the owner of the document to spend significant time and effort managing the revision process. Managing the process typically includes keeping track of: a) which drafts or sections of the draft have been shared with which reviewers; b) which reviewers have responded with input; c) which edits and comments have been accepted or rejected; d) which drafts contain edits from each reviewer.

In addition to the time and effort expended managing this process, it can be error-prone, creating inefficiencies and risks for the owner of the document. Errors can include: a) unintended inclusion or omission of input from a reviewer; b) including reviewer input in the incorrect draft; c) incorrect distribution of drafts or sections of drafts, to reviewers; d) omitted reviewer input caused by failure to follow up and receive input from a reviewer. When an error occurs, the process of recovering from the error often requires significant time and effort by the document owner and sometimes reviewers and may also have substantial cost. Tasks typically performed when recovering from an error include a) reviewing and comparing multiple drafts of the document to identify the point at which the error occurred and the source of the error; b) requesting reviewers to re-review drafts of a document; c) reapplying input received from reviewers (often over many drafts); d) validating that input from reviewers was received and considered; e) distributing drafts to additional reviewers.

Revision and version control systems often have features that depict revision history of a document, engineering specification, or software code. These features do not anticipate the various roles, objectives, and rights or permissions of each user. These features illustrate the entire revision history of a document including every branch and every revision. They are designed to present a common view to all users, not accounting for the specific varying roles, objectives, privacy expectations, and rights or permissions of an individual user.

Document owners and reviewers need to reduce the time and effort required to manage the document revision process, reduce the risk of introducing errors in the process, reduce the time and effort required to recover from errors when they do occur, and do so while maintaining confidentiality of the content, communications, and even the identity of the collaborators.

Thus, there is a need for a new means by which users can efficiently and effectively monitor and get answers to specific questions pertaining to the status of a document during its revision process, and take desired actions. Existing document creation and revision platforms such as Microsoft Office and Google Docs are unable to directly provide summarized yet, comprehensive information to users.

Similar concepts have been found within the prior art, however none of the systems presently on the market can facilitate the creation of a summarized history of a document graphically via an illustration or graph.

For example, Wall et al. teaches a Computer Method and Apparatus for Indicating Performance of Assets and Revisions Held in a Repository, filed on Oct. 22, 2007. The method and apparatus taught by Wall et al. is configured to denote changes made during the normal course of product revisions. As products evolve via revisions, Wall et al. facilitates visually depicting when revisions were made, by whom, and when. While both the system of the present invention and Wall et al. employ a form of visual grammar to facilitate the depiction of revisions, the concentration of Wall et al. on mechanical and engineering revisions does not lend itself well to the summarization of text documents. Wall et al. does not restrict the visual depiction of the revision history to specific branches based on user information, whereas the present invention employs user information about the role and permissions of the user to restrict the scope of the illustration created for the user. Wall et al. does not depict a summarized revision history based on actions or sequences of actions performed, whereas the present invention employs a summarization algorithm which uses a history of actions which have taken place in a specific sequence to determine when a version is displayed in an illustration. Wall et al. does not use a visual grammar which illustrates the status of a user activity related to a specific version, whereas the present invention employs specific indicators related to the activity of at least one user on a specific version. Wall et al. requires use of documented assets within a repository, whereas the present invention employs metadata to automatically map the progression of history to be found within an electronic document to streamline the revision process on behalf of numerous users. Additionally, unlike the present invention, Wall et al. is not configured to display detailed data beyond the interaction of assets as they relate to the engineered product over time.

Soderberg et al. teaches an Acrylic Graph Navigator, filed on Oct. 5, 2010, which is configured to create mapped illustrations pertaining to hosts, links, databases, and clusters. While Soderberg et al. employs a form of summary, it fails to be applicable to revisions of an individual electronic document by which historical data can be obtained. Unlike the present invention, Soderberg et al. is configured to be used by system administrators, and is not configured to display detailed data beyond the interaction of a network of processing elements directed to an acrylic graph. Unlike the present invention, Soderberg et al. is configured to create a composite acyclic graph from two or more acyclic graphs, and is not configured to create summarized graph of an electronic document from a revision history.

Wall et al. also teaches a Computer Method and Apparatus for Engineered Product Management Including Simultaneous Indication of Working Copy Status and Repository Status, filed on Oct. 22, 2007. Unlike the present invention, Wall et al. is not concentrated on specific file types, such as electronic documents, and instead attempts to govern all ‘assets’ or files based on changes, and summarizes the changes with a tabular format. Conversely, the present invention employs a hierarchical representation, denoting changes as they relate to a specific electronic document (and related drafts) with child and parent branches depicted within illustrations. In short, Wall et al. is relegated to depicting the history of design schematics as they relate to product development and engineering, which requires the use of numerous file formats, namely centering on visual and graphic design tools and formats. This is in contrast to the present invention, which is more stringently focused on text-based electronic-documents and their respective formats, and querying metadata of the files to automatically generate and populate a history of the electronic document which is depicted visually via a summarized illustration/graph. Additionally, the present invention is configured for use with electronic documents, rather than engineered products as Wall teaches. Further, the present invention integrates permissions that ensure only users afforded rights to view revision events from permitted users are displayed, unlike Wall et al, which has no need for such individual user rights.

Additionally, Wall et al. also teaches a Computer method and Apparatus for Engineered Product Management Using a Project View and A Visual Grammar, filed on Oct. 22, 2007. Within the application, Wall et al. shows a method directed to managing software configuration revisions, which depict a history of the development of the software. As software creation often requires the use of numerous assets to compile the desired program or output, multiple files are used. Wall et al. teaches this method to provide a project view and revision manager in order to manage these assets and their corresponding revisions throughout the course of development. In scope, Wall et al. does not craft the output maps graphically according to specific users' information. Additionally, unlike the present invention, access is universally available to users to view the history of changes during development, whereas the present invention only allows a user to view the changes (and who made them) when the user is provided permission to view the history summary. In contrast, the present invention truncates or otherwise alters the history summary illustration according to the permission the user is granted.

### SUMMARY OF THE PRESENT INVENTION

The present invention addresses the needs of both document owners and reviewers to understand the context of their actions relating to the revision of a document, taking into account their roles objectives, and permitted rights. Specifically, the present invention provides a method and system, which processes a complete set of revision history information about a document and produces a summarized view customized to the specific user requesting this information. This view is presented to the user as a graph, which may be interactive, and allow the user to request and control the display of detailed information and content related to one or more drafts of the document. This view, and the user interactions it may enable, are limited by the user's role and rights/permissions assigned by the document owner and the owner of a working draft (“branch”) of the document if the user is not the owner of the document or relevant branch.

The summarization is accomplished in several ways. First, the present invention constrains the user's view to their own branch, their parent branch (if any) and any child branches that the user may have created. Second, the present invention summarizes multiple revisions and actions along each branch to present a simpler representation of events and revisions relevant to the user. Third, the present invention employs visual indicators that enable the user to quickly understand within their context, the status of the revision process, the state of individual drafts and the relationship of drafts to each other. Finally, a graph is created and presented to the user. Additionally, the graph may provide an interface which can be used to request the display and/or comparison of drafts (or perform other functions) to which the user has the right to access.

### BRIEF DESCRIPTION OF THE DRAWINGS

The present invention will be better understood with reference to the appended drawing sheets, wherein:

FIG. 1 is an example block diagram of a computer network environment in which embodiments of the current invention are implemented.

FIG. 2 is a flow diagram of an example of a process to generate a document version map.

FIG. 3 is a block diagram of an example of a revision history branch structure of the present invention.

FIG. 4 is a block diagram of an example of a summarized revision history or version map

FIG. 5a is a flow diagram the algorithm to summarize the revision history

FIG. 5b is a continuation of the flow diagram of the algorithm to summarize the revision history

FIG. 6 is table of possible revision events and event sequences

FIG. 7 is a table providing an example of visual indicators for communicating status.

FIG. 8 illustrates an example UI presentation of the summary information.

### DETAILED DESCRIPTION OF THE PREFERRED EMBODIMENT

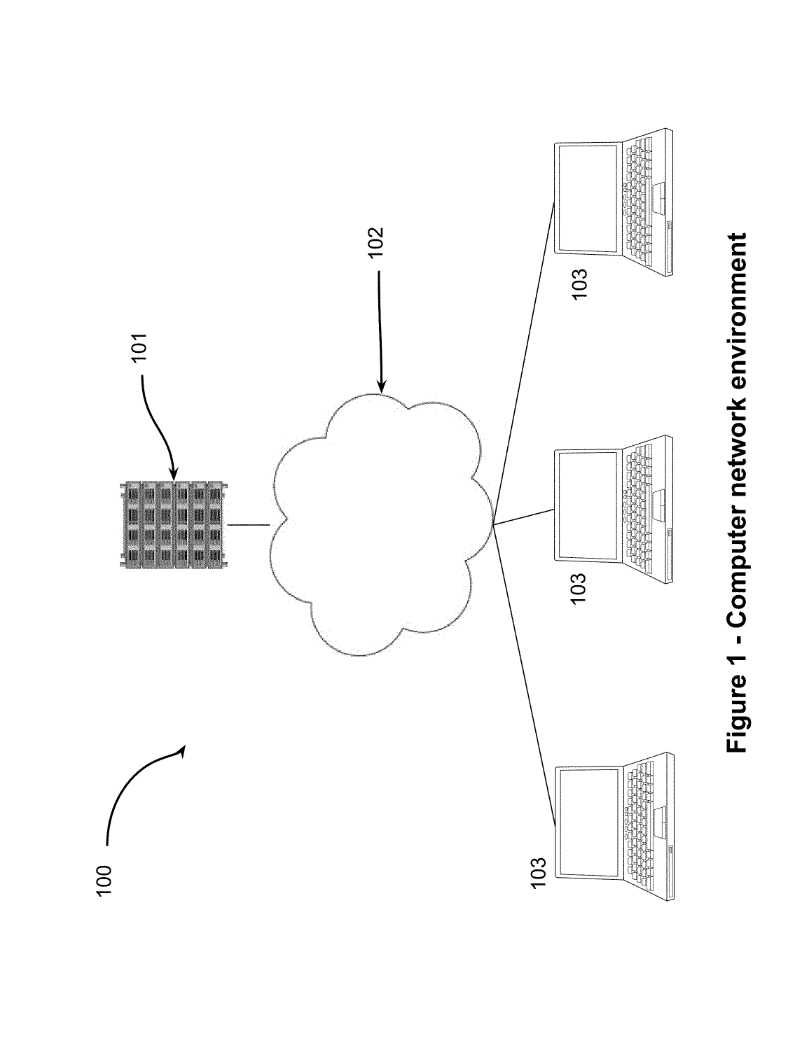

The present invention facilitates user interaction with revision management systems that permit collaborative editing of documents, including text documents, graphics documents, presentations, data sets, database records, code and/or spreadsheets. These systems are commonly implemented, as illustrated in FIG. 1, on computing systems 100 consisting of a host system 101 such as a server, communicating over a network 102 with each of a plurality of client computing systems 103. It should be understood that client computing systems 103 are envisioned to include conventional mobile devices including, but not limited to a tablet, a smartphone, a laptop computer, a PDA, or other similar network-connected device.

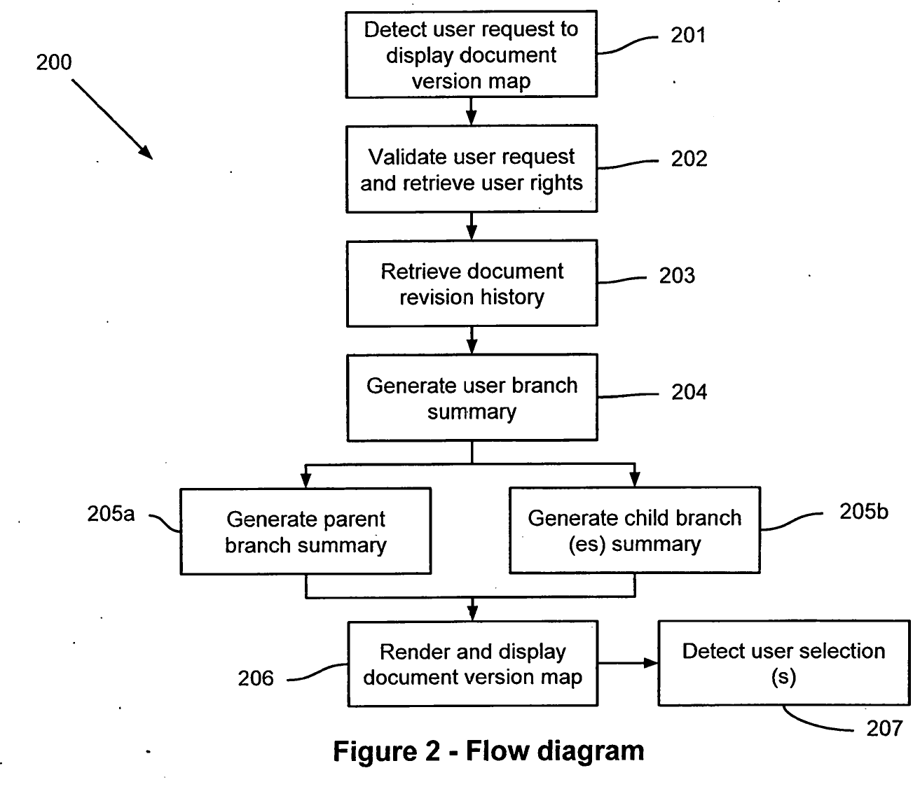

FIG. 2 illustrates the preferred embodiment of a computer-implemented process 200 for generating and displaying a summarized interactive document version map. The computer-implemented process 200 may be performed, for example, by the computing system 100, however another system, or combination of systems, may be used to perform the computer-implemented process 200.

The computer-implemented process 200 detects a user request 202 to display a version map 201, otherwise referenced as a graph or illustration. For example, a user may click an icon on a web browser indicating a request to view the document version map for a document currently being displayed within the browser window. A browser-based application residing on the user's client computing system 103 may send this request along with information identifying the current document and branch being viewed, the user's identification, authorization, and role/rights with respect to the document and branch to the host system 101. The host system 101 validates the request 202 and retrieves the document revision history 203. In other embodiments, a web browser may be replaced by another application executed on the user's client computing system 103 or on the host system 101. In other embodiments, this process may be triggered by another event, such as the user completing an action, or the system detecting a change in the status of the document or the users participating in the creation or review of the document.

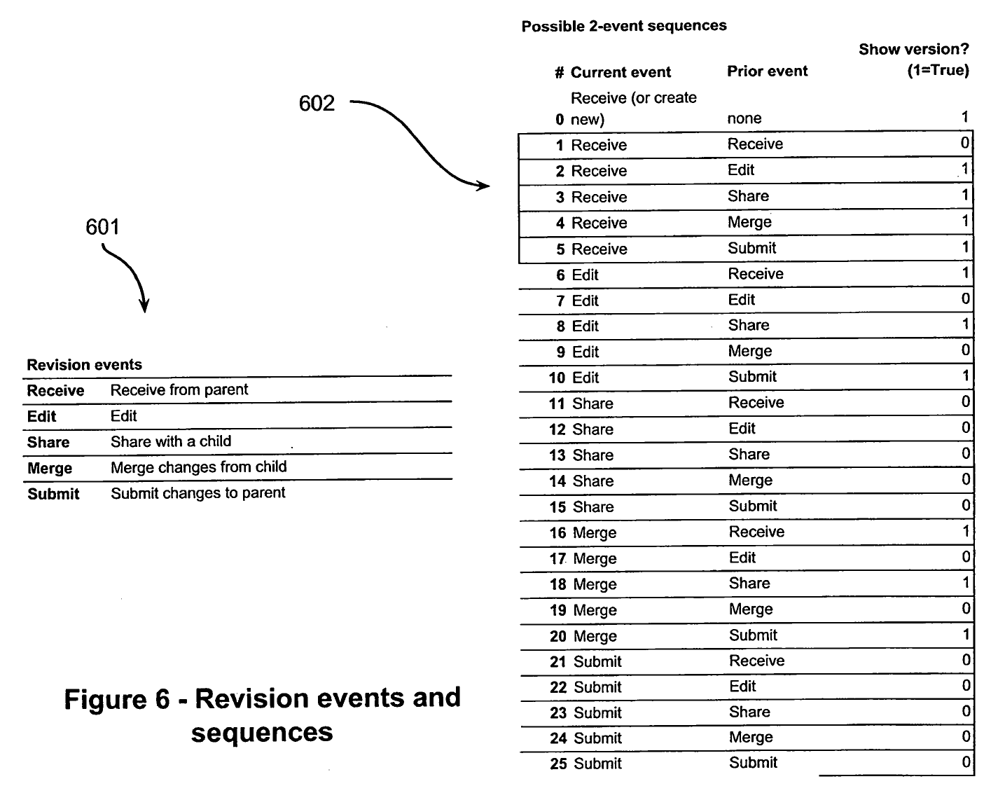

In the preferred embodiment, the document revision history is stored and updated by the host system including each revision event related to the document. In other embodiments, the revision history may be stored and updated separately from revision event information related to the document. FIG. 6 illustrates possible revision events 601 that may be stored with the revision history of the document. Using a revision history summarization algorithm 500, the host system or the client system may generate a user branch summary 204, a parent branch summary 205a, and child branch summary 205b. In the preferred embodiment of the present invention, the user branch summary 204 is generated before the parent branch summary 205a and child branch summaries 205b, however in other embodiments, these summaries may be generated in parallel, or in another sequence. Using these summaries, in the preferred embodiment of the present invention, the client system then renders and displays the user version map 206. In other alternate embodiments of the present invention, the host system may render the user version map 206 for display by the client computing system 103. Finally, in the preferred embodiment, the displayed version map 207 is configured to be interactive so that the client computing system 103 may detect user interactions and issue an appropriate request.

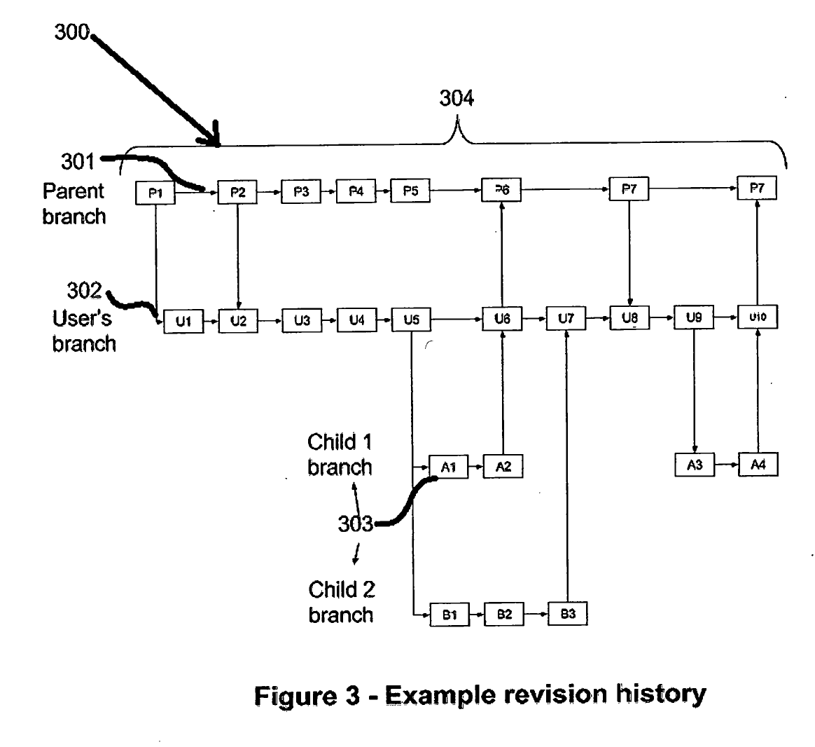

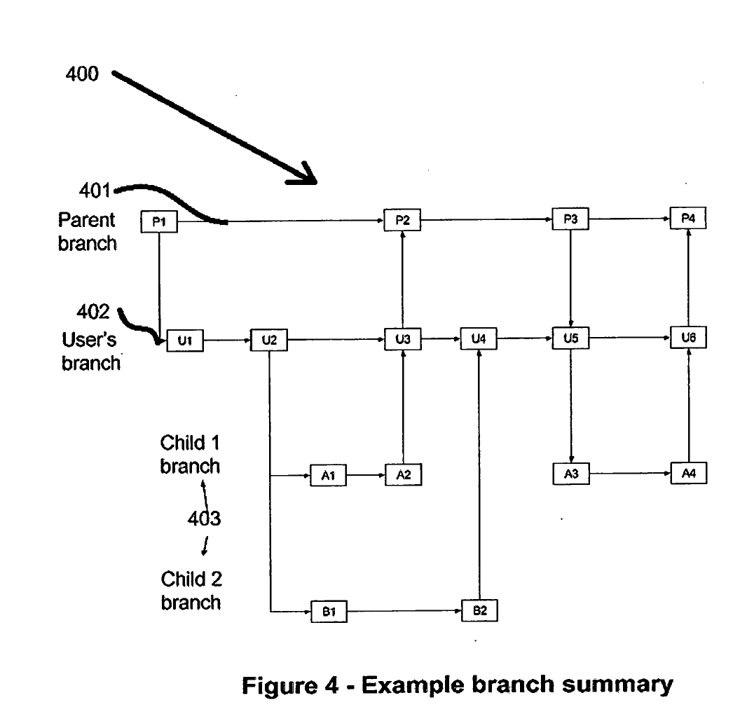

FIG. 3 illustrates an example of a revision history 300 for a user's current branch (user branch) 302, the corresponding parent branch 301, and all associated child branches 303. Each branch is composed of versions 304 which are designated by unique identifiers. Versions 304 on a branch can be created through the occurrence of a single revision event or a specific sequence of revision events. These revision events typically can be categorized as: a) a time-based event (e.g., a specific time or time interval, b) an action or sequence of actions initiated by a user or by a system. Examples of actions include: a) creating an initial version 304, b) accepting a version 304 from another branch, c) editing a prior version 304, d) modifying a prior version 304 by applying changes found by comparing with another version, or e) a user or system-initiated request that a new version 304 be created. In the preferred embodiment, the revision history and event information may then be processed by the host system to generate branch summaries as illustrated in FIG. 4. In other embodiments of the present invention, the revision history 300 and event information may be passed to a client computing system 103 for processing. The example of the user's version map 400 includes the user branch summary 402, a parent branch summary 401, and summary of all child branches 403.

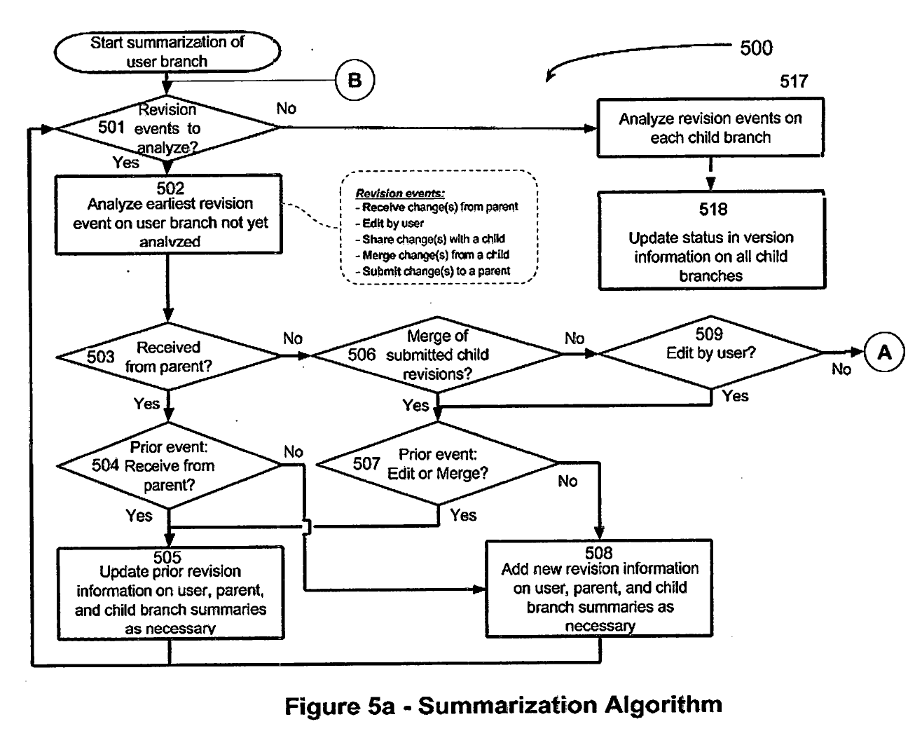

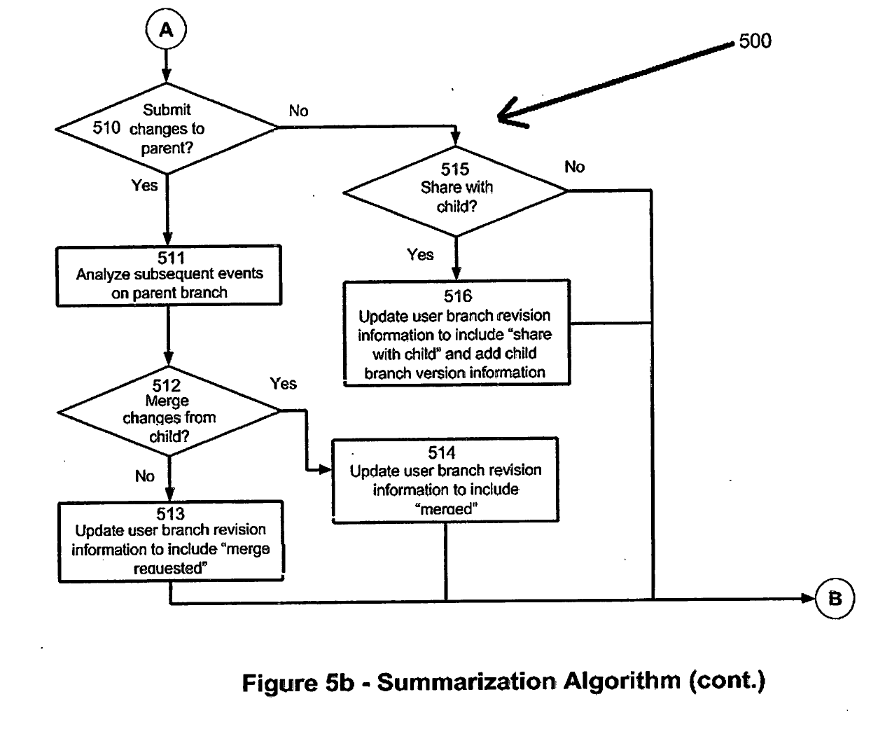

A user's version map 400 may be created by the host system 101 or client computing system 103 using a summarization algorithm. FIG. 5a and FIG. 5b are a flowchart illustrating the preferred embodiment of a branch version history summarization algorithm 500. The algorithm inputs are the revision events in the user branch, the parent branch, and each child branch associated with the user branch beginning with the earliest revision event on the user branch and analyzing each subsequent revision events in sequence. This output of the algorithm is a series of “version descriptors” on the user branch, the parent's branch, and each child branch associated with the user branch. Each version descriptor includes information identifying the revision events leading to the creation of the version descriptor, directly connected version descriptors both prior and subsequent, and status of the version.

The branch version history summarization algorithm 500 begins by identifying the earliest revision event related to the user branch that has yet to be summarized 501. The revision events 601 are analyzed to determine the event sequences 602 which have occurred on the user branch in order to create a version descriptor for a branch summary. If the revision event 601 is “Receive from parent” 503, the prior revision event is analyzed 504. If this prior revision event on the user branch is not “Receive from parent” or there is no prior revision event, a version descriptor is created in the user branch summary which includes information identifying the source revision event on the parent branch and a version descriptor is created in the parent branch summary which includes information identifying the user revision event 508. The process iterates through the analysis of each more recent revision event 501 on the user branch until all revision events have been analyzed.

Additionally, if this prior revision event was “Receive from parent”, the previously created version descriptor in the user branch summary is updated to include the current revision event information identifying the newer source revision event on the parent branch 505. The process iterates through the analysis of each more recent revision event 501 on the user branch until all revision events have been analyzed.

Additionally, if the revision event is determined to be “merge changes from child” 506, the prior revision event is analyzed 507. If this prior revision event on the user branch is not “Edit” or “Merge changes from child” or there is no prior revision event, a version descriptor is created in the user branch summary which includes information identifying the source revision event on the child branch and a version descriptor is created in the child branch summary which includes information identifying the user revision event 508. The process iterates through the analysis of each more recent revision event 501 on the user branch until all revision events have been analyzed.

Additionally, if this prior revision event was “Edit” or “Merge changes from child”, the previously created version descriptor in the user branch summary is updated to include the current revision event information identifying the newer source revision event on the child branch 505. The process iterates through the analysis of each more recent revision event 501 on the user branch until all revision events have been analyzed.

Additionally, if the revision event is determined to be “edit” 509, the prior revision event is analyzed 507. If this prior revision event on the user branch is not “Edit” or “Merge changes from child” or there is no prior revision event, a version descriptor is created in the user branch summary which includes information identifying the source revision event on the child branch and a version descriptor is created in the child branch summary which includes information identifying the user revision event 508. The process iterates through the analysis of each more recent revision event 501 on the user branch until all revision events have been analyzed.

Additionally, if this prior revision event was “Edit” or “Merge changes from child”, the previously created version descriptor in the user branch summary is updated to include the current revision event information identifying the newer source revision event on the child branch 505. The process iterates through the analysis of each more recent revision event 501 on the user branch until all revision events have been analyzed.

Additionally, if the revision event is determined to be “Submit changes to parent” 510, subsequent revision events on the parent branch are analyzed 511 to identify a “Merge changes from child” revision event corresponding to revision event on the user branch 512. If no revision event is identified, the previously created version descriptor in the user branch summary is updated to include the current revision information identifying the pending state of the “merge requested” 513. If a subsequent “merge changes from child” revision event is identified on the parent branch corresponding to the revision event 508 on the user branch, the previously created version descriptor in the user branch summary 402 is updated to include the current revision information identifying the resolved state of the “merged” revision event 514. The process iterates through the analysis of each more recent revision event 501 on the user branch until all revision events have been analyzed.

Additionally, if the revision event 501 is determined to be “Share with child” corresponding to one or more child branches 515, the previously created version descriptor in the user branch summary is updated to include the current revision event information identifying the shared status on the user branch and an additional version descriptor on each of the child branch summaries is then added 516. The process iterates through the analysis of each more recent revision event 501 on the user branch until all revision events have been analyzed.

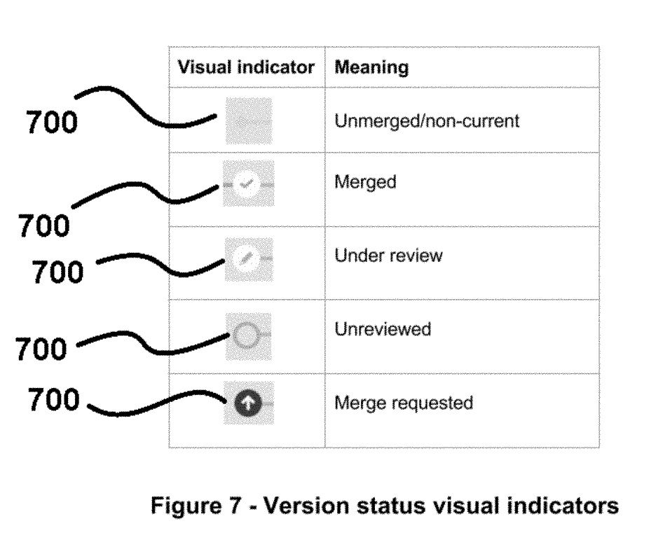

If there are no further user branch revision events to be analyzed 517, each of the revision events created on each child branch is analyzed to determine the status of each version descriptor 518. Each child branch version descriptor is then updated to reflect its current status. Each child branch version descriptor may be assigned one of five possible statuses: 1) “unmerged/non-current”, 2) “merged”, 3) “under review”, 4) “unreviewed”, 5) “merge requested.” Unmerged/non-current status is assigned to version descriptors summarizing revision events that have been superseded by a share revision event to the child branch prior to a merged revision event being created on the child branch. “Merged” status is assigned to version descriptors summarizing a sequence of revision events ending with a “merge” revision event on the parent branch. “Under review” status is assigned to version descriptors summarizing a sequence of revision events beginning with a “share” revision event from the child's parent branch and ending with an “editing” revision event on the child's branch. “Unreviewed” status is assigned to version descriptors summarizing a single “shared” revision event by the child's parent branch. “Merge requested” status is assigned to version descriptors summarizing revision events beginning with a “shared” revision event from the child's parent branch and ending with “merge requested” revision event on the child branch. FIG. 7 illustrates visual indicators 700 of these statuses.

Other embodiments may employ algorithms that vary in the revision events 601 event sequences 602 evaluated, and the sequences in which the events and event sequences are evaluated could vary. In addition, other embodiments results of an algorithm may be stored not as version descriptors but instead as action descriptors referencing specific versions. As shown in FIG. 6, revision events include Receiving, Editing, Sharing, Merging, and Submitting. Receiving is defined as a user receiving a version of the electronic document from another user. The ‘edit’ revision event occurs when the electronic document has bene edited by the user, or by the user who sent the electronic document initially. The ‘share’ revision event occurs when the electronic document is shared with another user on a child branch (below the user). Changes are merged from the child during the ‘merge’ revision event, and the ‘submit’ revision event makes the changes that were enacted to the parent branch (accepting the changes).

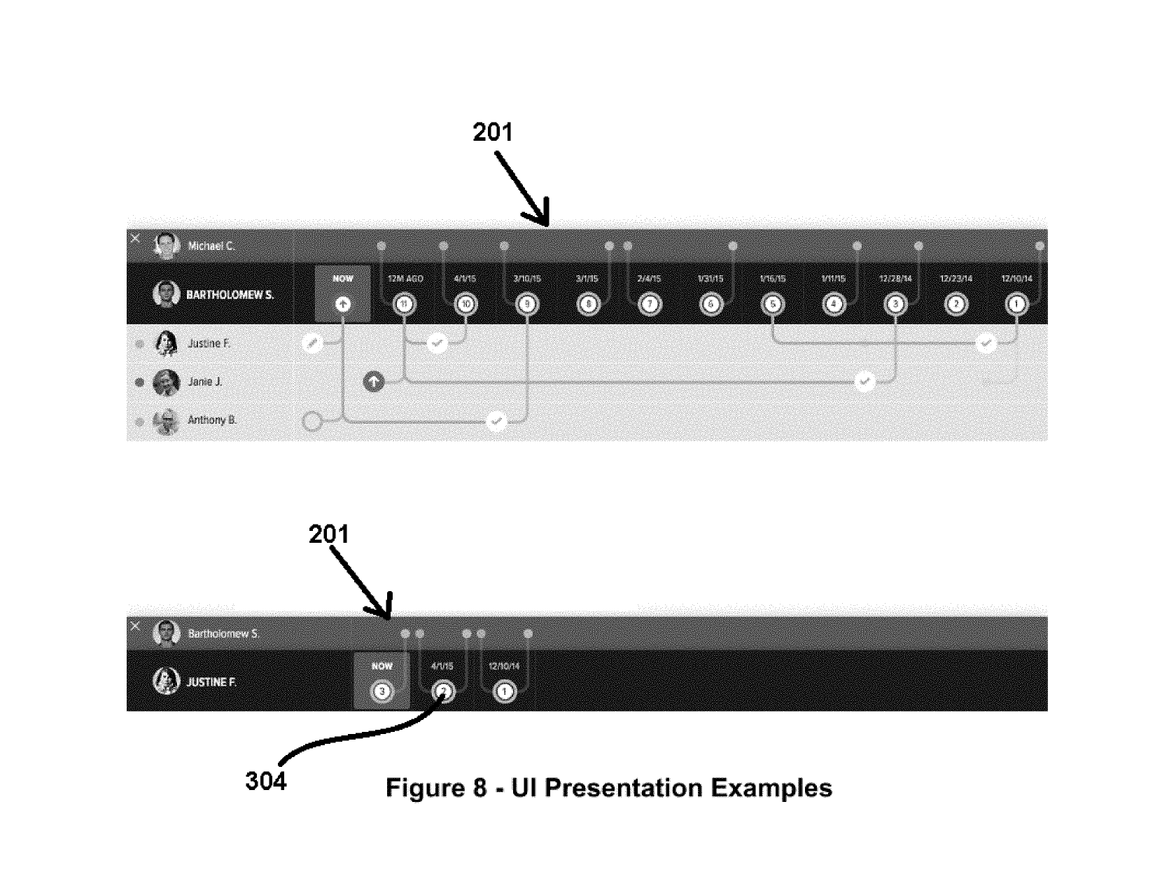

In the preferred embodiment, the host system 101 sends the summarized information to the client computing system 103. The client computing system 103 then renders and displays the user's document version map 201. In another embodiment the host system may render the user's document version map 201 and send the rendering to the client system for display. In another embodiment the client system renders and displays the user's document version map 201 from the summarized information is has already processed. FIG. 8 illustrates examples of two different users' version maps 201 for a document. FIG. 8 illustrates a version map 201 for a user with a parent and three child branches. This user's version map 201 represents actions and versions 304 directly related to the user and his/her parent, and his/her children. The lower portion of FIG. 8 illustrates a version map 201 for a user who is a child of the user whose version map 201 is illustrated at the top of FIG. 8. This child user's version map 201 only represents actions and versions 304 that relate directly to the user. If the version map 201 is enabled as an interactive user interface, the browser-based application then detects one or more selections by the user. In one example, the user may select a version 304 to display. In another example, the user may select multiple versions 304 to compare.

Having illustrated the present invention, it should be understood that various adjustments and versions might be implemented without venturing away from the essence of the present invention. Further, it should be understood that the present invention is not solely limited to the invention as described in the embodiments above, but further comprises any and all embodiments within the scope of this application.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment was chosen and described in order to best explain the principles of the present invention and its practical application, to thereby enable others skilled in the art to best utilize the present invention and various embodiments with various modifications as are suited to the particular use contemplated.

We claim:

1. A computer-implemented method, comprising:
saving an electronic history of revisions of an electronic document;
graphically displaying which of multiple users last revised the electronic document; and
showing the electronic history of revisions between a first user and a second user, such that the electronic history of revisions is from the perspective of the second user;
wherein the electronic history of revisions of the electronic document is not graphically displayed every time the first user and the second user revise the electronic document.

2. The method of claim 1, further comprising showing the electronic history of revisions between a second user and a third user, such that the electronic history of revisions is from the perspective of the second user.

3. The method of claim 1, further comprising creating a version of the electronic document based upon the electronic history of revisions.

4. The method of claim 1, further comprising graphically displaying the electronic history of revisions of the electronic document in a row.

5. The method of claim 1, further comprising graphically displaying the electronic history of revisions of the electronic document with a version number.

6. The method of claim 1, further comprising graphically displaying the electronic history of revisions of the electronic document alongside the second user.

7. The method of claim 1, further comprising graphically displaying the first user above the second user.

8. The method of claim 2, further comprising graphically displaying the second user above the third user.

9. The method of claim 1, further comprising graphically displaying additional users, beyond the third user, below the third user.

10. The method of claim 1, further comprising graphically displaying a link between at least one user and the electronic history of revisions of the electronic document.

11. The method of claim 1, further comprising graphically not displaying a link between the second user and the electronic history of revisions of the electronic document if only the second user has edited a document.

12. The method of claim 1, wherein said saving an electronic history of revisions of an electronic document is performed according to certain actions performed on the electronic document.

13. The method of claim 12, wherein the certain actions performed on the electronic document are chosen from the group: receiving the document or creating a new document with no prior event; receiving the document and editing the document; receiving the document and sharing the document; receiving the document and merging the document; receiving and submitting the document; editing the document and receiving the document; editing the document and sharing the document; editing the document and submitting the document; merging the document and receiving the document; merging the document and sharing the document; merging the document and submitting the document.

14. The method of claim 12, wherein the certain actions performed on the electronic document are performed in a particular sequence.

15. The method of claim 13, wherein a first action of each pair of actions of the group is performed before a second action of each pair of actions of the group.

16. The method of claim 2, further comprising displaying the electronic history of revisions of the first user and the third user to the second user because the second user has permission to view the electronic history of revisions of the first user and the third user.

17. The method of 14, further comprising indicating a status of a version of the electronic history of revisions as chosen from the group: version is under review by a user; version is being revised by a user; version has not yet been reviewed by a user; version has been superseded by a more recent version; version has been submitted to another user for review and merging with another version; version has been reviewed and merged with another version.

18. A computer-implemented method, comprising:
saving an electronic history of revisions of an electronic document;
graphically displaying which of multiple users last revised the electronic document;
showing the electronic history of revisions between a first user and a second user, such that the electronic history of revisions is from the perspective of the second user;
wherein the electronic history of revisions of the electronic document is not graphically displayed every time the first user and the second user revise the electronic document;
further comprising showing the electronic history of revisions between a second user and a third user, such that the electronic history of revisions is from the perspective of the second user;
further comprising creating a version of the electronic document based upon the electronic history of revisions;
further comprising graphically displaying the electronic history of revisions of the electronic document in a row;
further comprising graphically displaying the electronic history of revisions of the electronic document with a version number;
further comprising graphically displaying the electronic history of revisions of the electronic document alongside the second user;
further comprising graphically displaying the first user above the second user;
further comprising graphically displaying the second user above the third user;
further comprising graphically displaying additional users, beyond the third user, below the third user;
further comprising graphically displaying a link between at least one user and the electronic history of revisions of the electronic document;
further comprising graphically not displaying a link between the second user and the electronic history of revisions of the electronic document if only the second user has edited a document;
wherein said saving an electronic history of revisions of an electronic document is performed according to certain actions performed on the electronic document;
wherein the certain actions performed on the electronic document are chosen from the group: receiving the document or creating a new document with no prior event; receiving the document and editing the document; receiving the document and sharing the document; receiving the document and merging the document; receiving and submitting the document; editing the document and receiving the document; editing the document and sharing the document; editing the document and submitting the document; merging the document and receiving the document; merging the document and sharing the document; merging the document and submitting the document;
wherein the certain actions performed on the electronic document are performed in a particular sequence;
wherein a first action of each pair of actions of the group is performed before a second action of each pair of actions of the group;
further comprising displaying the electronic history of revisions of the first user and the third user to the second user because the second user has permission to view the electronic history of revisions of the first user and the third user; and
further comprising indicating a status of a version of the electronic history of revisions as chosen from the group: version is under review by a user; version is being revised by a user; version has not yet been reviewed by a user; version has been superseded by a more recent version; version has been submitted to another user for review and merging with another version; version has been reviewed and merged with another version.

19. A computer-implemented method, comprising:
sharing an electronic history of revisions of an electronic document;
graphically displaying which of multiple users last revised the electronic document depending the relationships amongst the multiple users; and
showing the electronic history of revisions between a first user and a second user, such that the electronic history of revisions is from the perspective of the second user;
wherein the electronic history of revisions of the electronic document is not always saved every time the first user and the second user revise the electronic document.
